(19) United States
(12) Patent Application Publication
(10) Pub. No.: US 2012/0289220 A1
(43) Pub. Date: Nov. 15, 2012

(54) METHOD AND APPARATUS FOR REALIZING INTEGRITY PROTECTION

(76) Inventors: Yi Yang, Beijing (CN); Ying Wang, Beijing (CN)

(21) Appl. No.: 13/520,562

(22) PCT Filed: Jan. 4, 2011
(86) PCT No.: PCT/CN11/70013

§ 371 Date: Jul. 6, 2012

(30) Foreign Application Priority Data
Jan. 4, 2010 (CN) 201010033652.7

(51) Int. Cl. H04W 4/00

(52) U.S. Cl. 455/422.1

(57) ABSTRACT

Provided in the present invention are a method, an apparatus and a system for realizing integrity protection. The method includes the following steps: a relay node (RN) receives a message, from a base station, carrying integrity protection information; the RN provides integrity protection for the transmitted data according to the integrity protection information. The embodiments of the present invention can provide integrity protection for the data that requires the integrity protection, especially for S1-AP messages and X2-AP messages.

The present application claims the priority of the Chinese patent application with the application date of Jan. 4, 2010, the application number of 201010033652.7, and the patent name of “method, apparatus and system for realizing integrity protection”, all content of the priority application is combined into the present application by quoting.

### FIELD OF THE PRESENT INVENTION

The present invention relates generally to the field of mobile communication technology, and more particularly to method, apparatus and system for realizing integrity protection.

BACKGROUND OF THE PRESENT INVENTION

In future mobile communication system, such as B3G (Beyond Third Generation) or LTE-A (Long Term Evolution-Advanced) system, the system would provide higher peak data rate and cell throughput, and need more larger bandwidth. At present, few un-used frequency band below 2 GHz is left, B3G system can only seek a part of or all of requisite bandwidth at higher frequency band, for example the frequency band above 3 GHz. Radio waves have faster attenuation and shorter transmission distance on higher band. Accordingly, more base stations would be needed for consecutive coverage at same coverage region. More base stations would increase network deployment cost because usually base station has expensive price. To solve the problem of network deployment cost, many vendors and standardization organizations begin to introduce RN (Relay Node) into cellular communication system.

FIG. 1 is overall LTE-A network architecture with deployed RN. Therein, RN is wirelessly connected to DeNB (Donor Evolved Node B), and access the core network via donor cell. RN doesn't have direct wired interface with core network, and each RN can manage one or more cells. The interface between UE (User Equipment) and RN is called Uu interface, the interface between DeNB and RN is called Un interface.

At the above-mentioned network architecture, RN has double identities, viz. UE identity and eNB (evolved Node B) identity. First, RN has UE identity when startup. The RN's startup procedure is similar to legacy UE attachment procedure. RN has its own S-GW/P-GW (Serving Gateway/PDN Gateway) and control plane node MME (Mobility Management Entity). All data packets destined to RN would pass the S-GW/P-GW of RN, the S-GW/P-GW of RN would send the data packet to the serving DeNB of RN. DeNB sends the data packet to RN on Un interface. Then, RN has eNB identity for UE. Downlink data of UE is sent form S-GW/P-GW of UE to the serving RN of UE, and then RN sends downlink data to UE on Uu interface.

At the present, four alternative architectures are put forward in 3GPP (3rd Generation Partnership Project), and the present invention has relation with candidate architecture 1, 2, and 3. Therein, startup procedure of candidate architecture 1 RN comprises: RN uses the legacy UE attachment procedure to register in MME. MME obtains subscription data of RN from HSS (Home Subscriber Server) and then establishes EPS (Evolved Packet System) default bearer for RN in S-GW/P-GW. Subsequently, MME of RN sends Initial Context Setup Request to the DeNB of RN, triggering establishment RN radio bearer between DeNB and RN. O&M (Operation and Maintenance) system authenticates RN after the EPS bearer of RN has been established. If RN passes authentication, the O&M downloads configuration data into RN. RN can start normal operation after establishing necessary S1 interface and X2 interface.

RN startup procedure of candidate architecture 2 comprises: RN uses the legacy UE attachment procedure to register in MME, MME obtains subscription data of RN from HSS and establishes RN EPS default bearer in DeNB. Subsequently, MME of RN sends Initial Context Setup Request to the DeNB of RN, triggering establishment RN radio bearer between DeNB and RN. O&M (Operation and Maintenance) system authenticates RN after EPS bearer of RN has been established. If RN passes authentication, the O&M downloads configuration data into RN. RN establishes one S1 interface and one X2 interface with DeNB, and then DeNB updates existing S1 connection and X2 connection. RN can start normal operation.

The difference between candidate architecture 3 and candidate architecture 1 is that function of S-GW/P-GW is integrated in DeNB. other procedures are the same as in candidate architecture 1.

Data transmission process and bearer mapping relation of candidate architecture 1 and candidate architecture 3 comprising: at downlink direction, P-GW/S-GW of UE encapsulates IP data packet of UE into GTP (GPRS Tunnelling Protocol) tunnel destined to RN, and sends it to P-GW/S-GW of RN. P-GW/S-GW of RN maps the received IP data packet into RN EPS bearer and sends it to DeNB after encapsulating it in GTP tunnel. IP data packets which have the same QoS (Quality of Service) can be mapped into the same RN EPS bearer. DeNB maps received RN GTP tunnel to RN radio bearer of Un interface and sends to RN. Finally, RN maps received IP data packet to UE DRB (Data Radio Bearer) of Uu interface according to UE GTP tunnel of interior layer and sends to UE. At uplink direction, RN maps received data packet to EPS bearer of RN.

Data transmission process and bearer mapping relation of candidate architecture 2 comprising: in downlink direction, IP data packet which is sent to UE is mapped into GTP tunnel of UE spanned from P-GW/S-GW of UE to DeNB. DeNB maps UE GTP tunnel to RN DRB in Un interface one by one according to QCI. UE EPS bearers which have same QCI could be mapped into the same RN DRB. RN maps UE GTP tunnel to UE DRB in Uu interface and sends received packet to UE. In uplink direction, bearer mapping function of RN is similar to DeNB.

QoS mechanism is an important feature in EPS, which can provide guarantee about transmission efficiency and reliability for different service, and maintain good experience. QoS control of EPS is based on bearer. An End-to-end service comprises EPS bearer and external bearer, therein, EPS bearer belongs to EPS scope, and external bearer relies on the system outside EPS. EPS bear architecture of candidate architecture 1, 2, 3, is depicted in FIG. 2, therein, EPS bearer between UE and P-GW is divided into E-RAB (E-UTRAN Radio Access Bearer) between UE and S-GW and S5/S8 bearer between S-GW and P-GW. E-RAB could also be divided into Uu bearer between UE and RN and S1 bearer between RN and S-GW. Uu bearer between UE and RN is a radio bearer, and S1 bearer and RN DRB are one-to-one mapping relationship. When RN is introduced, EPS bearer also includes RN EPS. RN EPS bearer usually has established before UE EPS bearer is setup. When RN is startup, Un bearer is setup between RN and DeNB. Un bearer is a radio bearer, which comprises RN SRB (for signalling) and RN DRB (for user data).

All data packet between UE and P-GW should be mapped to corresponding UE EPS bearer for transmission. Each network node schedules and transmits data packet according to QoS parameter of bearer allocated for the data packet. For LTE system, E-RAB ID is equal to EPS Bearer ID.

QoS parameters of EPS bearer level comprise: ARP (Allocation and Retention Priority characteristics), QCI (QoS Class Identifier), GBR (Guaranteed Bit Rate) and MBR (Maximum Bit Rate). Each node in E-UTRAN determines how to group data based on above-mentioned QoS parameter to satisfy QoS. Therein, APP is used to determine whether establishment and update of a bearer is accepted or rejected when resource is limited; APP can also be used for determining whether release an existing bearer is allowed or not when resource is limited accidentally (such as handover) at radio access network. QCI is a parameter related to radio access network, which is used for controlling transmission policy of data packet, such as scheduling, admission, queuing management and link layer protocol configuration. GBR indicates the transmission rate allocated for a GBR bearer, MBR is the upper limitation of transmission rate allocated for a GBR. In current specification, MBR should be equal to GBR.

In process to achieve the present invention, the inventor finds that at least the following problems exist in current technology:

S1-AP (S1 Interface Application Protocol) messages sent to UE from MME are transmitted on RN DRB in Un interface. In current LTE security mechanism, radio interface doesn't provide integrity protection for user data. Subsequently, if S1-AP messages are protected in PDCP (Packet Data Convergence Protocol) layer, they are not integrity protected or protected by enhanced security demand, i.e. activate integrity protection for DRB on Un interface. However, it would reduce available bandwidth in radio interface and decrease user experiences for real-time service if integrity protection is activated for all data bearer on radio interface. If NDS/IP (Network Domain Security for IP based protocol) mechanism is used to provide integrity protection for S1-AP messages and X2-AP (X2 Interface Application Protocol) messages on Un, it would lead to serious efficiency degrade in resource-limited radio interface, because IPsec mechanism bring extra IP header cost.

### SUMMARY OF THE PRESENT INVENTION

The embodiment of the present invention provides a method, apparatus and system for realizing integrity protection, using for providing integrity protection for data which needs integrity protection, particularly for S1-AP messages and X2-AP messages in a manner which does not increase the system load.

The embodiment of the present invention provides a method for realizing integrity protection, comprising the following steps:

relay node RN receiving the message which carrying integrity protection information from base station;

said RN providing integrity protection for being transmitted data according to said integrity protection information.

The embodiment of the present invention provides a method for realizing integrity protection, comprising the following steps:

said base station sending message which carrying integrity protection information to RN;

said base station providing integrity protection for being transmitted data according to said integrity protection information.

The embodiment of the present invention provides a RN, comprising:

receiving module, is used for receiving the message which carrying integrity protection information from base station;

executing module, is used for executing integrity protection for being transmitted data according to said integrity protection information.

The embodiment of the present invention provides a base station, comprising:

sending module, is used for sending message which carrying integrity protection information to RN;

executing module, is used for executing integrity protection for being transmitted data according to the integrity protection information which sent by said sending module.

The embodiment of the present invention provides a system for realizing integrity protection, comprising:

base station, is used for sending message which carrying integrity protection information to RN, and executing integrity protection for being transmitted data according to said integrity protection information;

RN, is used for receiving the message which carrying integrity protection information from base station, executing integrity protection for being transmitted data according to said integrity protection information.

The technical proposal of the embodiments of the present invention has the following advantage: Providing integrity protection for data which needs integrity on Un interface by activating integrity protection per bearer, particularly the bearer which transmitting S1-AP messages and X2-AP messages.

### BRIEF DESCRIPTION OF THE DRAWINGS

FIG. 1 is LTE-A system architecture diagram with deployed RN.

FIG. 2 is EPS bearer service architecture diagram.

FIG. 3 is a flow diagram of the method for realizing integrity protection in embodiment 1 of the present invention.

FIG. 4 is a flow diagram of the method for realizing integrity protection in embodiment 2 of the present invention.

FIG. 5 is a flow diagram of the method for realizing integrity protection in embodiment 3 of the present invention.

FIG. 6 is a flow diagram of the method for realizing integrity protection in embodiment 4 of the present invention.

FIG. 7 is a flow diagram of the method for realizing integrity protection in embodiment 5 of the present invention.

FIG. 8 is a structure diagram of RN in embodiment 6 of the present invention.

FIG. 9 is a structure diagram of RN in embodiment 7 of the present invention.

FIG. 10 is a structure diagram of base station in embodiment 8 of the present invention.

FIG. 11 is a structure diagram of base station in embodiment 9 of the present invention.

FIG. 12 is a structure diagram of base station in embodiment 10 of the present invention.

FIG. 13 is a structure diagram of system for realizing integrity protection in embodiment 11 of the present invention.

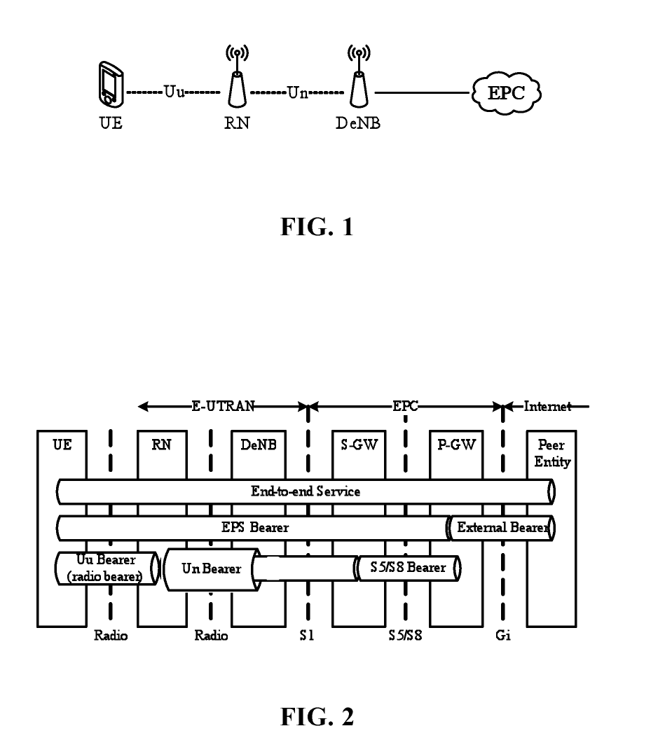

### DETAILED DESCRIPTION OF THE EMBODIMENTS OF THE PRESENT INVENTION

The embodiment of the present invention provides a method for realizing integrity protection of S1-AP messages and X2-AP messages on radio interface, MME establishes bearer for RN to transmit S1-AP messages and X2-AP messages during RN startup procedure, or base station independently establishes several RN DRBs to transmit S1-AP messages and X2-AP messages during RN startup procedure, or activating integrity protection for some bearers with specific QoS to transmit S1-AP messages and X2-AP messages.

Embodiment of this invention will be clearly and completely described with following figures. Apparently, the following embodiment is only a part of this invention, but not the whole invention. All the embodiments achieved by general technical staff in this field based on this application without creative work belong to the protection scope of the present application.

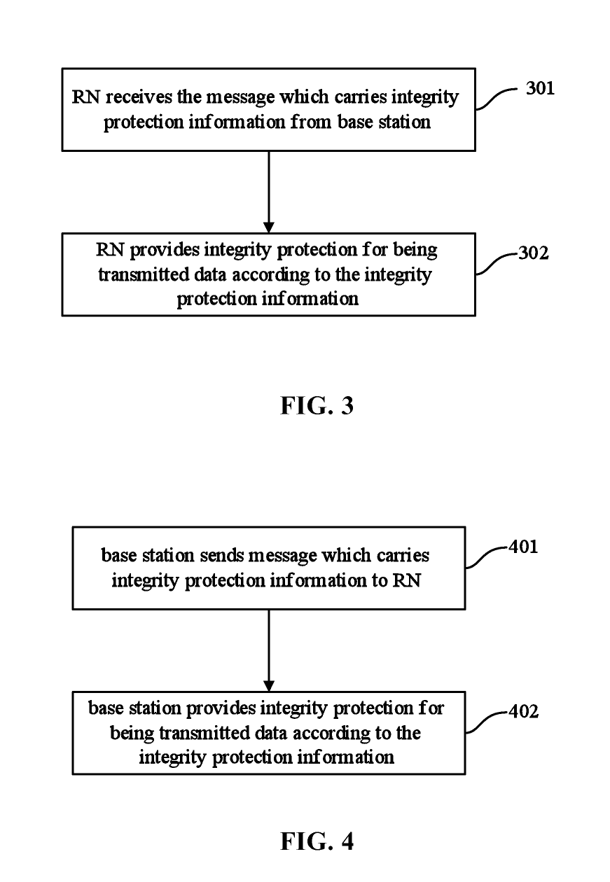

FIG. 3 is a flow diagram of the method for realizing integrity protection in embodiment 1 of the present invention, comprising the following steps:

Step 301, RN receives the message which carries integrity protection information from base station.

Step 302, RN provides integrity protection for being transmitted data according to the integrity protection information.

Specifically, before above-mentioned RN receives the message which carries integrity protection information from base station, further comprising: MME which serves RN sends Create Session Request message which carries establishment cause information for E-RAB to S-GW which serves RN; S-GW sends Create Session Request message which carries establishment cause information for E-RAB to P-GW which serves RN; MME sends Initial Context Setup Request message which carries establishment cause information for E-RAB or E-RAB Setup Request message which carries establishment cause information for E-RAB to base station; base station sends message which carries integrity protection information to RN, integrity protection information is used for indicating RN DRB which activates integrity protection.

Above-mentioned integrity protection information is used for transmitting RN DRB of S1-AP messages and RN DRB of X2-AP messages. Therein, S1-AP is S1 Interface Application Protocol, S1 interface is the interface between MME and eNB or the interface between MME and base station (i.e. DeNB), using for transmitting control plane information; X2-AP is X2 Interface Application Protocol, X2 interface is the interface between eNB and eNB, or the interface between eNB and base station, or the interface between RN and base station, namely, the interface between base station and base station, using for transmitting control plane information.

Before above-mentioned RN receives the message which carries integrity protection information from base station, further comprising: network side allocates specific QoS parameter for Un radio bearer; network side establishes bearer corresponding to QoS parameter when RN accesses to network, bearer is used for transmitting S1-AP messages and X2-AP messages.

Before above-mentioned network side allocates specific QoS parameter for Un radio bearer, further comprising:

RN requests network side to allocate specific QoS parameter for the is RN, parameter is used for transmitting S1-AP messages and X2-AP messages.

Therein, above-mentioned message which carries integrity protection information could be RRC Connection Reconfiguration message. It should be noted that the technical proposal of the embodiments of the present invention takes RRC Connection Reconfiguration message as example, but the invention is not limited by using RRC Connection Reconfiguration message, any specific message which carries integrity protection information could also realize the technical proposal of embodiment of the present invention.

The technical proposal of the embodiments of the present invention has the following advantage. Providing S1-AP messages and X2-AP messages with integrity protection on Un interface by activating integrity protection for the bearer which transmitting S1-AP messages and X2-AP messages.

FIG. 4 is a flow diagram of the method for realizing integrity protection in embodiment 2 of the present invention, comprising the following steps:

Step 401, base station sends message which carries integrity protection information to RN;

Step 402, base station provides integrity protection for being transmitted data according to the integrity protection information.

Specifically, before above-mentioned base station sends message which carries integrity protection information to RN, further comprising: base station receives Initial Context Setup Request message which carries establishment cause information for E-RAB or E-RAB Setup Request message which carries establishment cause information for E-RAB from MME which serves RN.

Before above-mentioned base station receives Initial Context Setup Request message which carries establishment cause information for E-RAB or E-RAB Setup Request information which carries establishment cause information for E-RAB from MME which serves RN, further comprising: MME sends Create Session Request message which carries establishment cause information for E-RAB to S-GW which serves RN; S-GW sends Create Session Request message which carries establishment cause information for E-RAB to P-GW which serves RN.

Before above-mentioned base station sends message which carries integrity protection information to RN, further comprising: network side allocates specific QoS parameter for Un radio bearer; network side establishes bearer corresponding to QoS parameter when RN accesses to network, bearer is used for transmitting S1-AP messages and X2-AP messages.

Before above-mentioned P-GW which serves RN allocating specific QoS parameter for Un radio bearer, further comprising: RN requests network side to allocate specific QoS parameter for RN, parameter is used for transmitting S1-AP messages and X2-AP messages.

Therein, above-mentioned message which carries integrity protection information could be RRC Connection Reconfiguration message.

The technical proposal of the embodiments of the present invention has the following advantage. Providing S1-AP messages and X2-AP messages with integrity protection on Un interface by activating integrity protection for the bearer which transmitting S1-AP messages and X2-AP messages.

FIG. 5 is a flow diagram of the method for realizing integrity protection in embodiment 3 of the present invention, comprising following steps:

Step 501, MME sends Create Session Request message which carries establishment cause information for E-RAB to S-GW.

Specifically, when RN startup, MME which serves RN initiates E-RAB establishment, and determine which E-RAB is used for transmitting S1-AP messages and X2-AP messages, and then includes establishment cause information for E-RAB in Create Session Request message sent to S-GW.

Therein, the establishment cause information for E-RAB includes three values: data, S1-AP and X2-AP; or includes only two values: data and signaling. If using the first classification method, S1-AP messages and X2-AP messages are transmitted in different bearers; if using the second classification method, S1-AP messages and X2-AP messages are transmitted in the same bearer.

Step 502, S-GW sends Create Session Request information which carries are transmitted information for E-RAB to P-GW.

Specifically, S-GW forwards received establishment cause information for E-RAB in Create Session Request information to P-GW.

Step 503, MME sends Initial Context Setup Request message which carries establishment cause information for E-RAB or E-RAB Setup Request message which carries establishment cause information for E-RAB to base station.

Specifically, as an example, an “E-RAB establishment cause” IE can be added in Initial Context Setup Request message or E-RAB Setup Request message. Table 1 is a format table of new enhancive IE/Group Name.

TABLE 1
IE/Group Name format table

| | | | | |
|---|---|---|---|---|
| | | | IE type | |
| IE/Group | | | and | Semantics |
| Name | Presence | Range | reference | description |

| | | |
|---|---|---|
| establishment | O | ENUMERATED |
| Cause | | {data, |
| | | signalling, |
| | | . . . } or |
| | | ENUMERATED |
| | | {data, |
| | | S1-AP, |
| | | X2-AP . . . |
| | | } |

Step 504, base station sends RRC Connection Reconfiguration message to RN, notifying which RN DRB needs to activate integrity protection to RN.

Specifically, if establishment cause information for E-RAB received by base station is used for transmitting S1-AP and X2-AP, base station activates integrity protection for the RN DRB when establishing RN DRB on Un interface, and notifies to RN which RN DRB need to activate integrity protection by RRC Connection Reconfiguration information. When base station and RN establish RN radio bearer on Un interface, integrity protection for above-mentioned RN E-RAB is activated.

Step 505, RN performs corresponding operation for RN DRB according to indication in received RRC Connection Reconfiguration.

Specifically, when RN and base station need to transmit S1-AP messages and X2-AP messages on Un interface, transmitting the message in RN radio bearer which has activated integrity protection.

Above-mentioned method applies to candidate architecture 1, 2, 3 in 3 GPP, therein, in candidate architecture 1 case, when P-GW sends S1-AP messages or X2-AP messages to RN in downlink direction, putting the message in already established RN EPS bearer; in uplink direction, RN puts S1-AP messages and X2-AP messages sent to base station in RN DRB which has already been established and activated integrity protection, as a consequence, S1-AP messages and X2-AP messages could obtain integrity protection on Un interface.

Candidate architecture 2 and candidate architecture 3 integrate S-GW/P-GW function in base station, accordingly, in downlink direction, when base station sends S1-AP messages or X2-AP messages to RN, transmitting the messages in RN DRB which has already been established and activated integrity protection; uplink direction transmission is the same with candidate architecture 1.

It should be noted that the step order in the embodiment of the present invention could be adjusted according to requirement.

The technical proposal of the embodiments of the present invention has the following advantages. Providing S1-AP messages and X2-AP messages with integrity protection on Un interface by activating integrity protection for the bearers which transmitting S1-AP messages and X2-AP messages. Resolving the problem that S1-AP messages and X2-AP messages can't obtain integrity protection when S1-AP messages and X2-AP messages are transmitted on radio data bearer according to existing technology and resolving the problem of radio interface efficiency decrease when Un interface activates integrity protection for all RN DRBs, it could realize integrity protection for S1-AP messages and X2-AP messages on Un interface. It could be used in LTE, 3G system and so on to ensure integrity protection or encryption in radio interface when necessary.

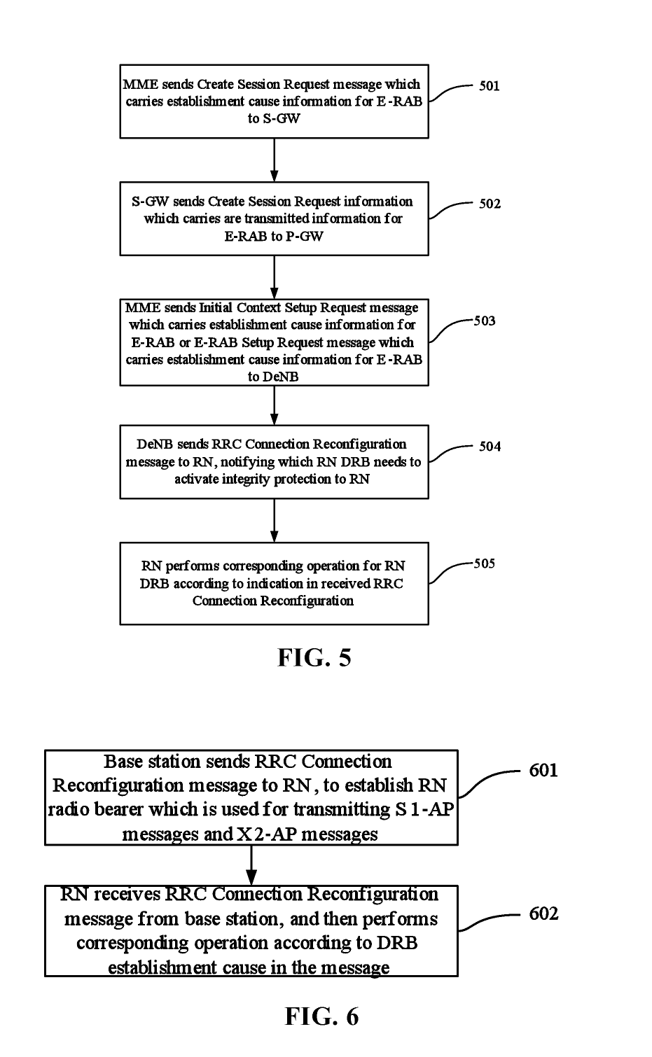

FIG. 6 is a flow diagram of the method for realizing integrity protection in embodiment 4 of the present invention, comprising following steps:

Step 601, base station sends RRC Connection Reconfiguration message to RN, to establish RN radio bearer which is used for transmitting S1-AP messages and X2-AP messages.

Therein, RadioResourceConfigDedicated IE in RRC Connection Reconfiguration message contains RN DRB establishment or modification information. Except for RN DRB required by core network, base station also could establish a number of additional RN DRBs used for transmitting S1-AP messages and X2-AP messages via RRC Connection Reconfiguration message, core network doesn't have corresponding E-RAB to above-mentioned RN DRB, that is to say, base station can independently establishes a number of RN DRB to transmit S1-AP messages and X2-AP messages. The establishment methods of RN DRB comprise following 3 solutions:

(1) base station could add indicator per new RN DRB in RadioResourceConfigDedicated IE, the indicator is used for indicating whether to activate integrity protection or not.

For RN DRB which is used for transmitting S1-AP messages or X2-AP messages, base station activates integrity protection; for RN DRB which is used for transmitting user data, base station doesn't activate integrity protection. The indicator of integrity activation could use Boolean style, for example, 1 means activation, 0 means non-activation; certainly, it also could use other protocol data style to indicate integrity activation.

(2) base station could add establishment cause per new RN DRB in RadioResourceConfigDedicated IE. Therein, establishment cause of RN DRB could be used for transmitting user data or signalling and so on.

DeNB sets establishment cause of RN DRB which is used for transmitting S1-AP messages and X2-AP messages to “signalling”, and activating integrity protection in PDCP entity configured for the RN DRB; base station sets establishment cause of RN DRB which is used for transmitting user data to “data”, and does not activate integrity protection in PDCP entity configured for the RN DRB.

Base station also could set establishment cause of RN DRB to “for user data”, “for S1-AP messages”, “for X2-AP messages” and so on.

Base station sets establishment cause of RN DRB which is used for transmitting S1-AP messages to “S1AP”, and activates integrity protection in PDCP entity configured for the RN DRB; base station sets establishment cause of RN DRB which is used for transmitting X2-AP messages to “X2AP”, and activates integrity protection in PDCP entity configured for the RN DRB; base station sets “data” for establishment cause of RN DRB which is used for transmitting user data, and does not activate integrity protection in PDCP entity configured for the RN DRB.

Base station also could combine above-mentioned two options to add establishment cause per new RN DRB in RadioResourceConfigDedicated IE.

It needs to illustrate that above-mentioned information element could be introduced in RadioResourceConfigDedicated IE in an optional way when establishing DRBs with RN. When UE is connected to base station directly, above-mentioned information element will not be introduced when establishing UE DRB on radio interface. It could save radio interface cost. Certainly, above-mentioned information element also could be used in a mandatory way.

Step 602, RN receives RRC Connection Reconfiguration message from base station, and then performs corresponding operation according to DRB establishment cause in the message.

Specifically, after RN DRB establish successfully, base station and RN put S1-AP messages and X2-AP messages which need transmitting on Un interface in corresponding RN DRB which has activated integrity protection to transmit. A RN radio bearer could transmit both S1-AP messages and X2-AP messages or transmit one of them barely.

Above-mentioned methods apply to candidate architecture 2 and 3 of 3GPP.

The technical proposal of the embodiments of the present invention have the following advantages. Providing S1-AP messages and X2-AP messages with integrity protection on Un interface by activating integrity protection for the bearers which transmitting S1-AP messages and X2-AP messages. Resolving the problem that S1-AP messages and X2-AP messages can't obtain integrity protection when S1-AP messages and X2-AP messages are transmitted on radio data bearer by existing technology, and resolving the problem of radio interface efficiency decrease when Un interface activates integrity protection for all RN DRBs, it could realize integrity protection for S1-AP messages and X2-AP messages on Un interface. It could be used in LTE, 3G system and so on to ensure integrity protection or encryption in radio interface when necessary.

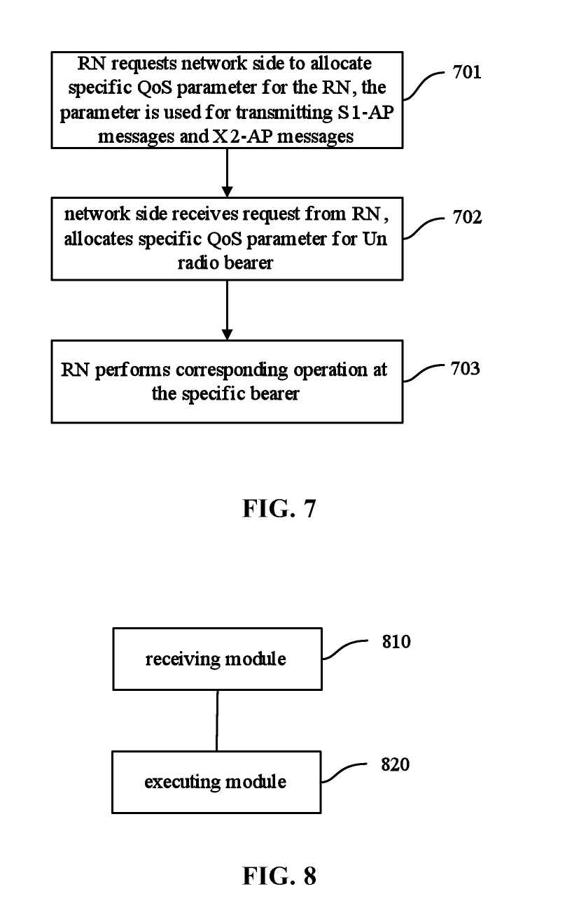

FIG. 7 is a flow diagram of the method for realizing integrity protection in embodiment 5 of the present invention, comprising following steps:

Step 701, RN requests network side to allocate specific QoS parameter for the RN, the parameter is used for transmitting S1-AP messages and X2-AP messages.

Therein, QoS parameter could be QCI, QCI has nine values at the present, and the values are one to nine respectively. Network side could increase a number of QCI value selections to transmit S1-AP messages and X2-AP messages, it could increase a number of RN DRBs (the number of RN DRBs are 8 at best at the present) or select one or more existing RN DRBs, the DRBs are used for transmitting S1-AP messages and X2-AP messages.

Specifically, when RN startup, it could request network to establish two bearers about QCI=10 and QCI=11 by single bearer resource allocation procedure or bearer resource modification procedure, for example, notifying network by setting QCI of Required traffic flow QoS IE to 10 and 11.

Step 702, network side receives request from RN, allocates specific QoS parameter for Un radio bearer.

Specifically, MME sends Bearer Resource Command to S-GW after receiving request from RN, S-GW forwards the Bearer Resource Command to P-GW.

Network side could establish new bearer resource for RN if the request of RN received by network side. P-GW sends Create Bearer Request message to S-GW, the message contains established bearer resources about QCI=10 and QCI=11. S-GW forwards Create Bearer Request message to MME. MME sends Initial Context Setup Request or E-RAB Setup Request to base station, notifying new bearer information to base station, base station activates integrity protection for new bearer which is used for transmitting S1-AP messages and X2-AP messages. Base station sends RRC Connection Reconfiguration message to RN, establishing RN DRB for above-mentioned bearer on Un interface. Above-mentioned Initial Context Setup Request or E-RAB Setup Request contains EPS bearer context activation information which MME sends to RN, RN establishes bearer which is used for transmitting S1-AP messages and X2-AP messages after receiving the message, and activates integrity protection for it on Un interface.

Network side could also modify existing bearer resource to transmit S1-AP messages and X2-AP messages for RN. P-GW sends Update Bearer Request message to S-GW, the message contains modified bearer resource about QCI=10 and QCI=11. S-GW forwards Create Bearer Request message to MME. MME sends E-RAB Modification Request to base station, notifying modified bearer information to base station. Base station activates integrity protection for modified bearer which is used for transmitting S1-AP messages and X2-AP messages. Base station sends RRC Connection Reconfiguration to RN, establishing RN DRB for above-mentioned bearer on Un interface. Above-mentioned E-RAB Modification Request contains EPS bearer context modification information sent to RN. When RN receives the massage, RN modifies corresponding bearer to transmit S1-AP messages and X2-AP messages, and activates integrity protection for it on Un interface.

Above-mentioned bearer resource allocation procedure or bearer resource modification procedure could also be completed with attachment procedure when RN startup.

P-GW establishes specific bearer corresponding to above-mentioned specific QoS parameter when RN accesses to network.

Specifically, supposing increased QCI values are 10 and 11. P-GW needn't establish two bearers about QCI=10 and QCI=11 when UE accesses. P-GW needs to establish above-mentioned two specific bearers to transmit S1-AP messages and X2-AP messages when RN accesses to network. MME, base station and RN acquiescently obtain that transmitting S1-AP messages and X2-AP messages at above-mentioned two bearers. PCRF needs to learn that access entity is UE or RN when RN startup.

Step 703, RN performs corresponding operation at the specific bearer.

Specifically, after specific bearer corresponding to specific QoS parameter has been setup, base station and RN transmit S1-AP messages is and X2-AP messages which need to be transmitted on Un interface in corresponding RN DRB, and the RN DRB has been activated integrity protection. A RN radio bearer could transmit S1-AP messages and X2-AP messages or transmit one of them barely.

It should be noted that network side can also initiate bearer setup or modification even when it doesn't receive request from RN. The newly established or modified bearer is used for transmitting S1-AP messages and X2-AP messages. The embodiment of the present invention applies to candidate architecture 1, 2, 3 in 3GPP.

The technical proposal of the embodiments of the present invention have the following advantages. Providing S1-AP messages and X2-AP messages with integrity protection on Un interface by activating integrity protection for the bearers which transmitting S1-AP messages and X2-AP messages. Resolving the problem that S1-AP messages and X2-AP messages can't obtain integrity protection when S1-AP messages and X2-AP messages are transmitted on radio data bearer by existing technology and resolving the problem of radio interface efficiency decrease when Un interface activates integrity protection for all RN DRBs, it could realize integrity protection for S1-AP messages and X2-AP messages on Un interface. It could be used in LTE, 3G system and so on to ensure integrity protection or encryption in radio interface when necessary.

FIG. 8 is a structure diagram of RN in embodiment 6 of the present invention, comprising:

receiving module 810, is used for receiving the message which carrying integrity protection information from base station.

executing module 820, is used for executing integrity protection for being transmitted data according to the integrity protection information.

Therein, above-mentioned message which carries integrity protection information could be RRC Connection Reconfiguration message.

The technical proposal of the embodiments of the present invention has the following advantage. Providing S1-AP messages and X2-AP messages with integrity protection on Un interface by activating integrity protection for the bearer which transmitting S1-AP messages and X2-AP messages.

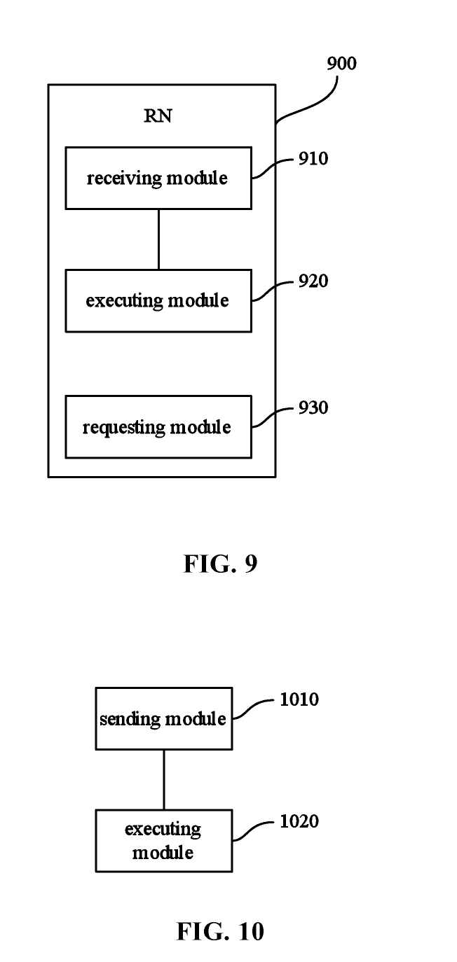

FIG. 9 is a structure diagram of RN in embodiment 7 of the present invention, the RN 900 comprises:

receiving module 910, is used for receiving RRC Connection Reconfiguration message from base station, RRC Connection Reconfiguration message carrying integrity protection information.

Executing module 920, is used for executing integrity protection for being transmitted data according to integrity protection information which being carried by RRC Connection Reconfiguration message received by receiving module 910.

Requesting module 930, is used for requesting network side to allocate specific QoS parameter, the parameter is used for transmitting S1-AP messages and X2-AP messages.

The technical proposal of the embodiments of the present invention has the following advantages. Providing S1-AP messages and X2-AP messages with integrity protection on Un interface by activating integrity protection for the bearers which transmitting S1-AP messages and X2-AP messages. Resolving the problem that S1-AP messages and X2-AP messages can't obtain integrity protection when S1-AP messages and X2-AP messages are transmitted radio data bearer by existing technology and resolving the problem of radio interface efficiency decrease when Un interface activates integrity protection for all RN DRBs, it could realize integrity protection for S1-AP messages and X2-AP messages on Un interface. It could be used in LTE, 3G system and so on to ensure integrity protection or encryption in radio interface when necessary.

FIG. 10 is a structure diagram of base station in embodiment 8 of the present invention, comprising:

sending module 1010, is used for sending the message which carrying integrity protection information to RN.

Executing module 1020, is used for executing integrity protection for being transmitted data according to the integrity protection information sent by sending module 1010.

Therein, above-mentioned message which carries integrity protection information could be RRC Connection Reconfiguration message.

The technical proposal of the embodiments of the present invention has the following advantage. Providing S1-AP messages and X2-AP messages with integrity protection on Un interface by activating integrity protection for the bearer which transmitting S1-AP messages and X2-AP messages.

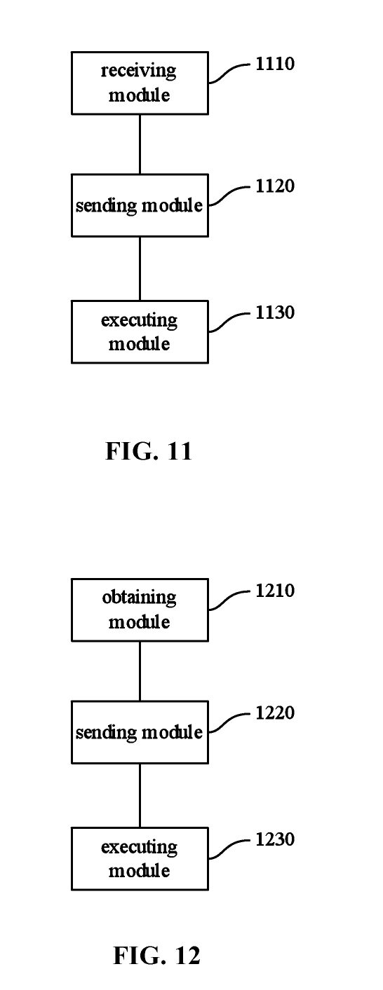

FIG. 11 is a structure diagram of base station in embodiment 9 of the present invention, comprising:

receiving module 1110, is use for receiving Initial Context Setup Request message which carrying establishment cause information for E-RAB or E-RAB Setup Request message which carrying establishment cause information for E-RAB from MME which serving RN, sending module 1120 using the establishment cause information which established by E-RAB.

Sending module 1120, is used for sending RRC Connection Reconfiguration message which carrying integrity protection information to RN.

Executing module 1130, is used for executing integrity protection is for being transmitted data according to integrity protection information which sent by sending module 1120.

The technical proposal of the embodiments of the present invention has the following advantages. Providing S1-AP messages and X2-AP messages with integrity protection on Un interface by activating integrity protection for the bearers which transmitting S1-AP messages and X2-AP messages. Resolving the problem that S1-AP messages and X2-AP messages can't obtain integrity protection when S1-AP messages and X2-AP messages are transmitted on radio data bearer by existing technology and resolving the problem of radio interface efficiency decrease when Un interface activates integrity protection for all RN DRBs, it could realize integrity protection for S1-AP messages and X2-AP messages on Un interface. It could be used in LTE, 3G system and so on to ensure integrity protection or encryption in radio interface when necessary.

FIG. 12 is a structure diagram of base station in embodiment 10 of the present invention, comprising:

obtaining module 1210, is used for receiving QoS parameter from MME which serving RN, parameter is used for transmitting S1-AP messages and X2-AP messages to be used by sending module.

Sending module 1220, is used for sending RRC Connection Reconfiguration message which carrying integrity protection information to RN.

Executing module 1230, is used for executing integrity protection for being transmitted data according to integrity protection information which sent by sending module 1220.

The technical proposal of the embodiments of the present invention has the following advantages: Providing S1-AP messages and X2-AP messages with integrity protection on Un interface by activating integrity protection for the bearers which transmitting S1-AP messages and X2-AP messages; Resolving the problem that S1-AP messages and X2-AP messages can't obtain integrity protection when S1-AP messages and X2-AP messages are transmitted on radio data bearer by existing technology and resolving the problem of radio interface efficiency decrease when Un interface activates integrity protection for all RN DRBs. It could realize integrity protection for S1-AP messages and X2-AP messages on Un interface. It could be used in LTE, 3G system and so on to ensure integrity protection or encryption in radio interface when necessary.

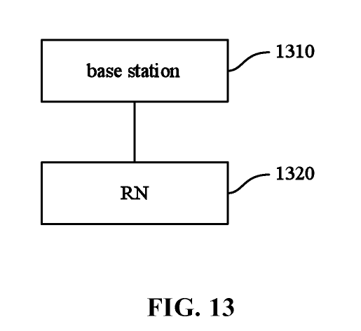

FIG. 13 is a structure diagram of system for realizing integrity protection in embodiment 11 of the present invention, comprising:

base station 1310, is used for sending message which carrying integrity protection information to RN 1320, and executing integrity protection for being transmitted data according to the integrity protection information;

RN 1320, is used for receiving the message which carrying integrity protection information from base station 1310, executing integrity protection for being transmitted data according to the integrity protection information.

Therein, above-mentioned message which carries integrity protection information could be RRC Connection Reconfiguration message.

The technical proposal of the embodiments of the present invention has the following advantages: Providing S1-AP messages and X2-AP messages with integrity protection on Un interface by activating integrity protection for the bearers which transmitting S1-AP messages and X2-AP messages.

Through the description of the embodiments above, the technical staff in this field can understand clearly that the present invention can be implemented by software and necessary current hardware platform. Of course, it also can be implemented by hardware, but in many situations the former is the better. Based on this understanding, essence or section with contribution to existing technology of the technical proposal of the present invention can be embodied by a form of software product which can be stored in a storage medium, including a number of instructions for making a computer device (such as mobile phone, personal computers, servers, or network equipments, etc.) implement the methods described in the embodiments of the present invention.

The descriptions above are just preferred implement ways of the present invention. It should be pointed that, for general technical personnel in this field, some improvement and decorating can be done, which should be as the protection scope of the present invention.

The technical staff in this field can understand the modules of the devices in the embodiments can be set in the devices according to the description of the embodiments, also can be set in one or more devices different from the embodiments. Modules in the above-mentioned embodiments can be integrated in one entirety, also can be deployed separately, can be combined into one module, also can be further split into multiple sub-modules.

Serial numbers of the above-mentioned embodiments of the present invention are only used for description. It does not express whether the embodiment is excellent or poor.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method for realizing integrity protection, wherein, comprising the following steps:
RN receiving the message which carrying integrity protection information from base station;
said RN providing integrity protection for being transmitted data according to said integrity protection information.

20. The method of claim 19, wherein, before said RN receiving the message which carrying integrity protection information from base station, further comprising:
MME which serving for said RN sending Create Session Request message which carrying establishment cause information for E-RAB to S-GW which serving said RN;
said S-GW sending Create Session Request message which carrying establishment cause information for E-RAB to P-GW which serving said RN;
said MME sending Initial Context Setup Request message which carrying establishment cause information for E-RAB or E-RAB Setup Request message which carrying establishment cause information for E-RAB to said base station;
said base station sending message which carrying integrity protection information to said RN, said integrity protection information is used for indicating RN DRB which needs to activate integrity protection.

21. The method of claim 19, wherein, said integrity protection information is used for transmitting RN DRB of S1-AP messages and RN DRB of X2-AP messages.

22. The method of claim 19, wherein, before said RN receiving the message which carrying integrity protection information from base station, further comprising:
network side allocating specific QoS parameter for Un radio bearer;
said network side establishing bearer corresponding to said QoS parameter when said RN accessing to network, said bearer is used for transmitting S1-AP messages and X2-AP messages.

23. The method of claim 20, wherein, before said RN receiving the message which carrying integrity protection information from base station, further comprising:
network side allocating specific QoS parameter for Un radio bearer;
said network side establishing bearer corresponding to said QoS parameter when said RN accessing to network, said bearer is used for transmitting S1-AP messages and X2-AP messages.

24. The method of claim 22, wherein, before said network side allocating specific QoS parameter for Un radio bearer, further comprising:
RN requesting network side to allocating specific QoS parameter for said RN, said parameter is used for transmitting S1-AP messages and X2-AP messages.

25. The method of claim 19, wherein, said message which carrying integrity protection information is RRC Connection Reconfiguration message.

26. A method for realizing integrity protection, wherein, comprising the following steps:
said base station sending message which carrying integrity protection information to RN;
said base station providing integrity protection for being transmitted data according to said integrity protection information.

27. The method of claim 26, wherein, before said base station sending message which carrying integrity protection information to RN further comprising:
said base station receiving Initial Context Setup Request message which carrying establishment cause information for E-RAB or E-RAB Setup Request message which carrying establishment cause information for E-RAB from MME which serving said RN.

28. The method of claim 27, wherein, before said base station receiving Initial Context Setup Request message which carrying establishment cause information for E-RAB or E-RAB Setup Request information which carrying establishment cause message for E-RAB from MME which serving said RN, further comprising:
said MME sending Create Session Request message which carrying establishment cause information for E-RAB to S-GW which serving said RN;
said S-GW sending Create Session Request message which carrying establishment cause information for E-RAB to P-GW which serving said RN.

29. The method of claim 26, wherein, before said base station sending message which carrying integrity protection information to RN, further comprising:
network side allocating specific QoS parameter for Un radio bearer;
said network side establishing bearer corresponding to said QoS parameter when said RN accessing to network, said bearer is used for transmitting S1-AP messages and X2-AP messages.

30. The method of claim 27, wherein, before said base station sending message which carrying integrity protection information to RN, further comprising:
network side allocating specific QoS parameter for Un radio bearer;
said network side establishing bearer corresponding to said QoS parameter when said RN accessing to network, said bearer is used for transmitting S1-AP messages and X2-AP messages.

31. The method of claim 29, wherein, before said network side allocating specific QoS parameter for Un radio bearer, further comprising:
said RN requesting network side to allocate specific QoS parameter for said RN, said parameter is used for transmitting S1-AP messages and X2-AP messages.

32. The method of claim 26, wherein, said message which carrying integrity protection information is RRC Connection Reconfiguration message.

33. A base station, wherein, comprising:
sending module, is used for sending message which carrying integrity protection information to RN;
executing module, is used for executing integrity protection for being transmitted data according to the integrity protection information which sent by said sending module.

34. The base station of claim 33, wherein, further comprising:
receiving module, is use for receiving Initial Context Setup Request message which carrying establishment cause information for E-RAB or E-RAB Setup Request message which carrying establishment cause information for E-RAB from MME which serving said RN, said sending module using the establishment cause information for said E-RAB.

35. A base station of claim 35, wherein, further comprising:
obtaining module, is used for receiving QoS parameter to be used by said sending module from MME which serving said RN, said parameter is used for transmitting S1-AP messages and X2-AP messages.

36. A base station of claim 34, wherein, further comprising:
obtaining module, is used for receiving QoS parameter to be used by said sending module from MME which serving said RN, said parameter is used for transmitting S1-AP messages and X2-AP messages.
